(19) United States
(12) Patent Application Publication
(10) Pub. No.: US 2025/0252964 A1
(43) Pub. Date: Aug. 7, 2025

(54) ELECTRONIC APPARATUS FOR BINAURAL SPEECH ENHANCEMENT AND OPERATING METHOD THEREOF

(71) Applicant: Samsung Electronics Co., Ltd., Suwon-si (KR)

(72) Inventors: Jeonghwan CHOI, Suwon-si (KR); Hangil MOON, Suwon-si (KR); Kyungho BANG, Suwon-si (KR); Jaemo YANG, Suwon-si (KR); Brian HAN, Suwon-si (KR)

(21) Appl. No.: 19/025,344

(22) Filed: Jan. 16, 2025

Related U.S. Application Data
(63) Continuation of application No. PCT/KR2024/020127, filed on Dec. 10, 2024.

(30) Foreign Application Priority Data
Feb. 5, 2024 (KR) 10-2024-0017421
Mar. 7, 2024 (KR) 10-2024-0032600

(51) Int. Cl. G10L 21/02

(52) U.S. Cl. CPC G10L 21/02

(57) ABSTRACT

An electronic device for binaural speech enhancement and a method of operating thereof are provided. The method of operating the electronic device includes: selecting speech data, room impulse response data, and noise data from a training database, determining a binaural input signal based on the selected speech data, the selected room impulse response data, and the selected noise data, obtaining a binaural output signal from a speech enhancement model based on a neural network with the binaural input signal as an input, determining a target binaural signal based on the selected speech data, the selected room impulse response data, and the selected noise data, and updating a parameter of the speech enhancement model, based on the obtained binaural output signal from the speech enhancement model and the determined target binaural signal.

### CROSS-REFERENCE TO RELATED APPLICATIONS

This application is a continuation of International Application No. PCT/KR2024/020127 designating the United States, filed on Dec. 10, 2024, in the Korean Intellectual Property Receiving Office and claiming priority to Korean Patent Application Nos. 10-2024-0017421, filed on Feb. 5, 2024, and 10-2024-0032600, filed on Mar. 7, 2024, in the Korean Intellectual Property Office, the disclosures of each of which are incorporated by reference herein in their entireties.

### BACKGROUND

### Field

The disclosure relates to an electronic device for binaural speech enhancement and an operating method thereof.

### Description of Related Art

An electronic device may provide a function related to audio signal processing. For example, the electronic device may provide a call function that collects and transmits audio signals, a recording function that records the audio signals, and an audio output function that outputs the audio signals. The electronic device may output audio through an external audio output device, such as earphones or headphones, or through an audio output module embedded in the electronic device. The earphones or the headphones are examples of binaural devices that include a left channel that outputs audio to a user's left ear and a right channel that outputs audio to the user's right ear.

### SUMMARY

According to an example embodiment, an electronic device may include: at least one processor, comprising processing circuitry, and one or more memories storing instructions executable by at least one processor, wherein the at least one processor, individually and/or collectively, is configured to execute the instructions and to cause the electronic device to: select speech data, room impulse response data, and noise data from a training database, determine a binaural input signal based on the selected speech data, the selected room impulse response data, and the selected noise data, obtain a binaural output signal from a speech enhancement model based on a neural network with the binaural input signal as an input, determine a target binaural signal based on the selected speech data, the selected room impulse response data, and the selected noise data, and update a parameter of the speech enhancement model, based on the obtained binaural output signal from the speech enhancement model and the determined target binaural signal.

According to an example embodiment, a method of operating an electronic device includes: selecting speech data, room impulse response data, and noise data from a training database, determining a binaural input signal based on the selected speech data, the selected room impulse response data, and the selected noise data, obtaining a binaural output signal from a speech enhancement model based on a neural network with the binaural input signal as an input, determining a target binaural signal based on the selected speech data, the selected room impulse response data, and the selected noise data, and updating a parameter of the speech enhancement model, based on the obtained binaural output signal from the speech enhancement model and the determined target binaural signal.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device according to various embodiments;

FIG. 2 is a block diagram illustrating an example configuration of an audio module according to various embodiments;

FIG. 3 is a diagram illustrating an example audio signal processing system including a binaural device and an electronic device, according to various embodiments;

FIG. 4 is a block diagram illustrating an example configuration of an electronic device for performing training operations of a speech enhancement model, according to various embodiments;

FIG. 5 is a diagram illustrating an example operation of selecting training data, according to various embodiments;

FIG. 6 is a diagram illustrating an example structure and example training operations of a speech enhancement model, according to various embodiments;

FIG. 7 is a flowchart illustrating an example method of operating an electronic device for training a speech enhancement model, according to various embodiments;

FIG. 8 is a flowchart illustrating example operations of determining a binaural input signal and a target binaural signal for training a speech enhancement model, according to various embodiments;

FIG. 9 is a flowchart illustrating example operations of obtaining diffuse noise data from a recorded audio signal, according to various embodiments;

FIG. 10 is a flowchart illustrating an example method of providing an audio signal using a speech enhancement model, according to various embodiments; and

FIG. 11 is a diagram illustrating quality improvement of an audio signal through binaural speech enhancement processing, according to various embodiments.

### DETAILED DESCRIPTION

Hereinafter, various example embodiments will be described in greater detail with reference to the accompanying drawings. When describing the various embodiments with reference to the accompanying drawings, like reference numerals refer to like elements, and a repeated description related thereto may not be provided.

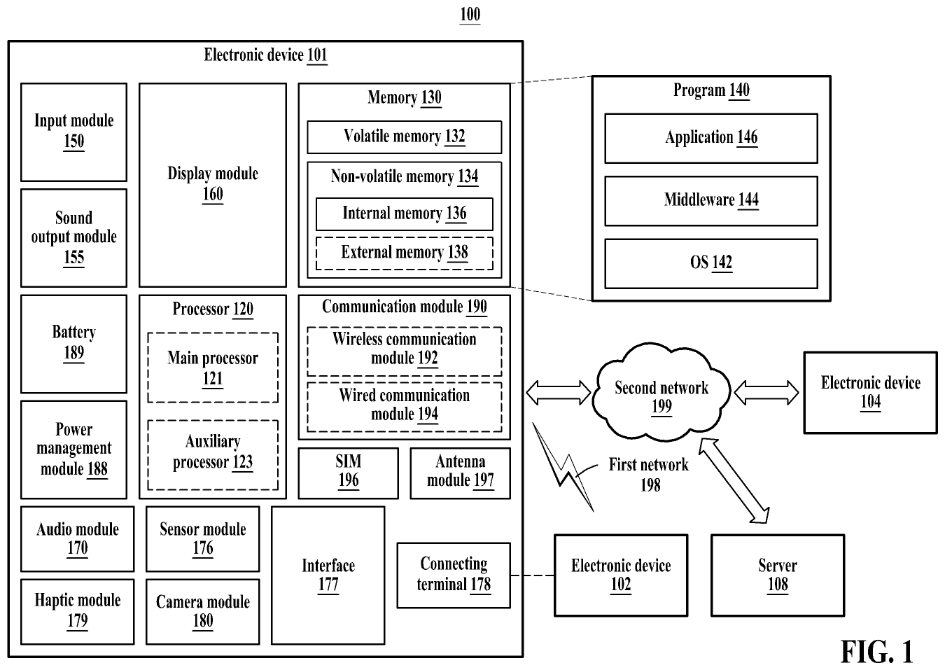

FIG. 1 is a block diagram illustrating an example electronic device for performing the operations described in the present disclosure according to various embodiments.

Referring to FIG. 1, an electronic device 101 in a network environment 100 may communicate with an electronic device 102 via a first network 198 (e.g., a short-range wireless communication network), or communicate with at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, a memory 130, an input module 150, a sound output module 155, a display module 160, an audio module 170, and a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be integrated as a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 connected to the processor 120 and may perform various data processing or computation. According to an embodiment, as at least a part of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. The processor 120 may be implemented as a system on chip (SoC) or an integrated circuit (IC) configured to perform processing. The processor 120 may include one or more processors. The operations of the electronic device 101 described in the present disclosure may be performed by one processor or by a combination of multiple processors. When the operations of the electronic device 101 are performed by the combination of the multiple processors, any one processor included in the combination of the multiple processors may perform some of the operations of the electronic device 101.

According to an embodiment, the processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently of, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101 instead of the main processor 121 while the main processor 121 is in an inactive (e.g., sleep) state or along with the main processor 121 while the main processor 121 is an active state (e.g., executing an application). According to an embodiment, the auxiliary processor 123 (e.g., an ISP or a CP) may be implemented as a portion of another component (e.g., the camera module 180 or the communication module 190) that is functionally related to the auxiliary processor 123. According to an embodiment, the auxiliary processor 123 (e.g., an NPU) may include a hardware structure specified for artificial intelligence model processing. An artificial intelligence model may be generated by machine learning. The machine learning may be performed by, for example, the electronic device 101, in which artificial intelligence is performed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but is not limited thereto. The artificial intelligence model may additionally or alternatively include a software structure other than the hardware structure.

The memory 130 may store various pieces of data used by at least one component (e.g., the processor 120 or the sensor module 176) of the electronic device 101. The various pieces of data may include, for example, software (e.g., the program 140), input data or display data for a command related thereto, and visual contents that may be displayed through the display module 160. The memory 130 may include the volatile memory 132 or the non-volatile memory 134. The memory 130 may store at least one instruction executable by the processor 120. The memory 130 may include one or more storage media (storage spaces). The instructions controlled by the processor 120 to perform the operations of the electronic device 101 described herein may be stored in one memory or divided and stored in multiple memories.

The program 140 may be stored as software in the memory 130, and may include, for example, an operating system 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing a recording. The receiver may be used to receive an incoming call. According to an embodiment, the receiver may be implemented separately from the speaker or as a part of the speaker.

The display module 160 may visually provide information to the outside (e.g., a user) of the electronic device 101. The display module 160 may include, for example, a display (e.g., a flexible touch display), a hologram device, or a projector and control circuitry to control a corresponding one of the display, the hologram device, and the projector. According to an embodiment, the display module 160 may include a touch sensor adapted to sense a touch, or a pressure sensor adapted to measure the intensity of a force incurred by the touch. The display module 160 may be implemented with, for example, a bendable structure, a foldable structure, and/or a rollable structure.

The audio module 170 may convert a sound into an electrical signal or vice versa. According to an embodiment, the audio module 170 may obtain the sound via the input module 150 or output the sound via the sound output module 155 or an external electronic device (e.g., an electronic device 102, such as a speaker, earphones, a hearing aid, or a headphone) directly or wirelessly connected to the electronic device 101.

The sensor module 176 may include one or more sensors. The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a bending sensor, an inertia measurement unit (IMU), a biosignal sensor, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., by wire) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may physically connect to an external electronic device (e.g., the electronic device 102). According to an embodiment, the connecting terminal 178 may include, for example, a HDMI connector, a USB connector, a SD card connector, or an audio connector (e.g., an earphone connector or a headphone connector).

The haptic module 179 may convert an electric signal into a mechanical stimulus (e.g., a vibration or a movement) or an electrical stimulus, which may be recognized by a user via their tactile sensation or kinesthetic sensation. According to an embodiment, the haptic module 179 may include, for example, a motor, a piezoelectric element, or an electric stimulator.

The camera module 180 may capture a still image and moving images. According to an embodiment, the camera module 180 may include one or more lenses, image sensors, ISPs, or flashes.

The power management module 188 may manage power supplied to the electronic device 101. According to an embodiment, the power management module 188 may be implemented as, for example, at least a part of a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., an AP) and that support direct (e.g., wired) communication or wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or IR data association (IrDA)) or the second network 199 (e.g., a long-range communication network, such as a legacy cellular network, a 5G network, a next-generation communication network, the Internet, or a computer network (e.g., a LAN or a wide area network (WAN)). These various types of communication modules may be implemented as a single component (e.g., a single chip) or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beamforming, or a large scale antenna. The wireless communication module 192 may support various requirements specified in the electronic device 101, an external electronic device (e.g., the electronic device 104), or a network system (e.g., the second network 199).

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or the power may be transmitted or received between the communication module 190 and the external electronic device via the at least one selected antenna. According to an embodiment, another component (e.g., a radio frequency integrated circuit (RFIC)) other than the radiating element may be additionally formed as a part of the antenna module 197.

According to an embodiment, the antenna module 197 may form a mm Wave antenna module. According to an embodiment, the mmWave antenna module may include a PCB, an RFIC disposed on a first surface (e.g., a bottom surface) of the PCB or adjacent to the first surface and capable of supporting a designated a high-frequency band (e.g., the mm Wave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and exchange signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 or 104 may be a device of the same type as or a different type from the electronic device 101. According to an embodiment, all or some of operations to be executed by the electronic device 101 may be executed at one or more external electronic devices (e.g., the external devices 102 and 104, and the server 108). For example, if the electronic device 101 needs to perform a function or a service automatically, or in response to a request from a user or another device, the electronic device 101, instead of, or in addition to, executing the function or the service, may request one or more external electronic devices to perform at least portion of the function or the service. The one or more external electronic devices receiving the request may perform the at least part of the function or service, or an additional function or an additional service related to the request and may transfer a result of the performance to the electronic device 101. The electronic device 101 may provide the result, with or without further processing the result, as at least part of a response to the request. To that end, cloud computing, distributed computing, mobile edge computing (MEC), or client-server computing technology may be used, for example. The electronic device 101 may provide ultra-low-latency services using, e.g., distributed computing or MEC. In an embodiment, the external electronic device (e.g., the electronic device 104) may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

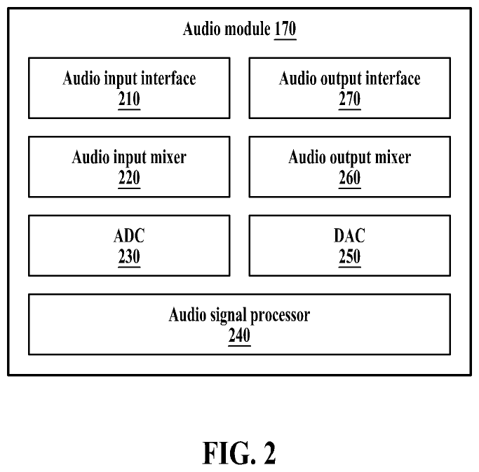

FIG. 2 is a block diagram illustrating an example configuration of an audio module according to various embodiments.

Referring to FIG. 2, the audio module 170 may include an audio input interface (e.g., including audio input circuitry) 210, an audio input mixer 220, an analog-to-digital converter (ADC) 230, an audio signal processor (e.g., including audio signal processing circuitry) 240, a digital-to-analog converter (DAC) 250, an audio output mixer 260, and an audio output interface (e.g., including audio output circuitry) 270. Some of the components of the audio module 170 may be omitted, and other components may be further included in the audio module 170.

The audio input interface 210 may include various circuitry and receive an audio signal corresponding to a sound obtained from the outside of the electronic device 101 via a microphone (e.g., a dynamic microphone, a condenser microphone, or a piezo microphone) that is configured as part of the input module 150 or separately from the electronic device 101. For example, if an audio signal is obtained from the external electronic device 102 (e.g., earphones, a hearing aid, a headset, or a microphone), the audio input interface 210 may be connected to the external electronic device 102 directly via the connecting terminal 178, or wirelessly (e.g., Bluetooth™ communication) via the wireless communication module 192 to receive the audio signal. According to an embodiment, the audio input interface 210 may receive a control signal (e.g., a volume adjustment signal received via an input button) related to the audio signal obtained from the external electronic device 102. The audio input interface 210 may include a plurality of audio input channels and may receive a different audio signal via a corresponding one of the plurality of audio input channels, respectively. According to an embodiment, additionally or alternatively, the audio input interface 210 may receive an audio signal from another component (e.g., the processor 120 or the memory 130) of the electronic device 101.

The audio input mixer 220 may synthesize a plurality of input audio signals into at least one audio signal. For example, the audio input mixer 220 may synthesize a plurality of analog audio signals input via the audio input interface 210 into at least one analog audio signal.

The ADC 230 may convert an analog audio signal into a digital audio signal. For example, the ADC 230 may convert an analog audio signal received via the audio input interface 210 or, additionally or alternatively, an analog audio signal synthesized via the audio input mixer 220 into a digital audio signal.

The audio signal processor 240 may include various audio signal processing circuitry and perform various processing on a digital audio signal received via the ADC 230 or a digital audio signal received from another component of the electronic device 101. For example, the audio signal processor 240 may perform changing a sampling rate, applying one or more filters, interpolation processing, amplifying, or attenuating a whole or partial frequency bandwidth, noise processing (e.g., attenuating noise or echoes), changing channels (e.g., switching between mono and stereo), mixing, or extracting a specified signal for one or more digital audio signals. According to an embodiment, one or more functions of the audio signal processor 240 may be implemented in the form of an equalizer.

The DAC 250 may convert a digital audio signal into an analog audio signal. For example, the DAC 250 may convert a digital audio signal processed by the audio signal processor 240 or a digital audio signal obtained from another component (e.g., the processor 120 or the memory 130) of the electronic device 101 into an analog audio signal.

The audio output mixer 260 may synthesize a plurality of audio signals, which are to be output, into at least one audio signal. For example, the audio output mixer 260 may synthesize an analog audio signal converted by the DAC 250 and another analog audio signal (e.g., an analog audio signal received via the audio input interface 210) into at least one analog audio signal.

The audio output interface 270 may include various circuitry and output an analog audio signal converted by the DAC 250 or, additionally or alternatively, an analog audio signal synthesized by the audio output mixer 260 to the outside of the electronic device 101 via the sound output module 155. The sound output module 155 may include, for example, a receiver or a speaker, such as a dynamic driver or a balanced armature driver. According to an embodiment, the sound output module 155 may include a plurality of speakers. In this case, the audio output interface 270 may output audio signals having a plurality of different channels (e.g., stereo channels or 5.1 channels) via at least some of the plurality of speakers. According to an embodiment, the audio output interface 270 may be connected to the external electronic device 102 (e.g., earphones, a hearing aid, a headset, or an external speaker) directly via the connecting terminal 178 or wirelessly via the wireless communication module 192 to output an audio signal.

According to an embodiment, the audio module 170 may generate, without separately including the audio input mixer 220 or the audio output mixer 260, at least one digital audio signal by synthesizing a plurality of digital audio signals using at least one function of the audio signal processor 240.

According to an embodiment, the audio module 170 may include an audio amplifier (not shown) (e.g., a speaker amplifying circuit) that may amplify an analog audio signal input via the audio input interface 210 or an audio signal that is to be output via the audio output interface 270. According to an embodiment, the audio amplifier may be configured as a module separate from the audio module 170.

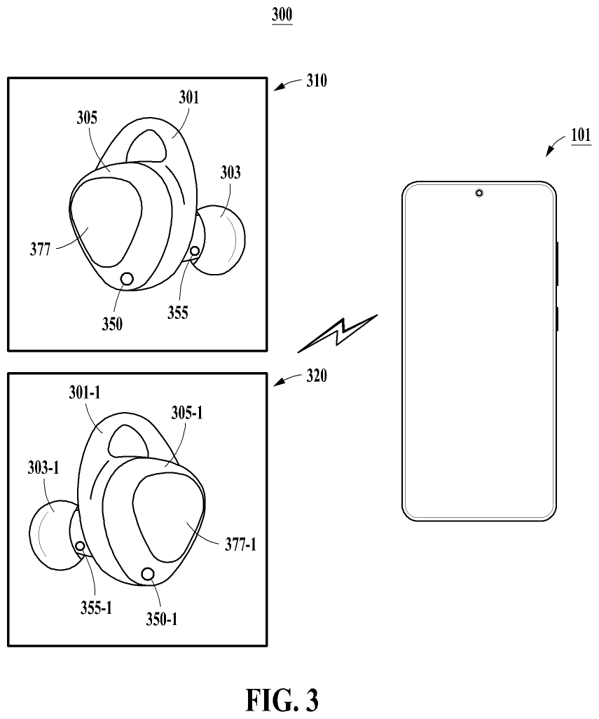

FIG. 3 is a diagram illustrating an example audio signal processing system including a binaural device and an electronic device, according to various embodiments.

Referring to FIG. 3, an audio signal processing system 300 may include the electronic device 101 and a binaural device 310 or 320. According to an embodiment, the binaural device 310 or 320 may be connected to the electronic device 101 by wire or wirelessly and may output an audio signal transmitted by the electronic device 101. The binaural device 310 or 320 may be a device for outputting binaural audio signals of two channels to both ears of a user. For example, the binaural device 310 or 320 may include earphones (wireless earphones or wired earphones), a headset, a hearing aid, smart glasses, or the like, but examples are not limited thereto.

According to an embodiment, as illustrated in the drawing, the binaural device 310 or 320 may be a wireless earphone for forming a short-range communication channel (e.g., a Bluetooth™ module-based communication channel) with the electronic device 101. For example, the binaural device 310 or 320 may include a true-wireless stereo (TWS), a wireless headphone, and/or a wireless headset. The binaural device 310 or 320 is illustrated as a kernel-type wireless earphone in FIG. 3, but examples are not limited thereto. For example, the binaural device 310 or 320 may be a stem-type wireless earphone in which at least a portion of the housing protrudes in a predetermined direction to collect a good user speech signal. According to an embodiment, the binaural device 310 or 320 may be a wired earphone connected to the electronic device 101 by wire.

The binaural device 310 or 320 may include the binaural device 310 that outputs an audio signal for a left channel corresponding to the user's left ear and the binaural device 320 that outputs an audio signal for a right channel corresponding to the user's right ear. The binaural device 310 or 320 may obtain (or collect) an external audio signal (or an audio signal) using a plurality of microphones and may transmit the obtained audio signal to the electronic device 101.

According to an embodiment, the binaural device 310 or 320, illustrated as an earphone-type device, may include a housing 301 or 301-1 (or a case) including an insertion portion 303 or 303-1 that may be inserted into the user's ear and a mounting portion 305 or 305-1 that is connected to the insertion portion 303 or 303-1 and may be mounted at least partially on the user's auricle. The binaural device 310 or 320 may include a plurality of microphones 350, 350-1, 355, and 355-1. For example, the binaural device 310 may include the microphones 350 and 355, and the binaural device 320 may include the microphones 350-1 and 355-1.

According to an embodiment, the binaural device 310 or 320 may include an input interface 377 or 377-1 including various interface circuitry configured to receive a user input. The input interface 377 or 377-1 may include, for example, a physical interface (e.g., a physical button or a touch button) and a virtual interface (e.g., a gesture, object recognition, or voice recognition). According to an embodiment, the binaural device 310 or 320 may include a touch sensor for detecting contact with the user's skin. For example, the binaural device 310 or 320 may include an area (e.g., an area corresponding to the input interface 377 or 377-1) in which the touch sensor is placed. According to an embodiment, the user input may be applied by the user touching the area with a body part. This touch input may include, for example, a single touch, multiple touches, a swipe, and/or a flick.

According to an embodiment, the microphones 350, 350-1, 355, and 355-1 mounted in the binaural device 310 or 320 may perform the function of the input module 150 described above with reference to FIG. 1. The description of the input module 150 described with reference to FIG. 1 may not be repeated here. For example, a first microphone 350 or 350-1 among the microphones 350, 350-1, 355, and 355-1 may be in the mounting portion 305 or 305-1 such that at least a portion of a sound hole may be exposed to the outside from the inside of the ear to collect external ambient sound while the binaural device 310 or 320 is worn on the user's ear. A second microphone 355 or 355-1 among the microphones 350, 350-1, 355, and 355-1 may be near the insertion portion 303 or 303-1. For the second microphone 355 or 355-1 to collect a signal transmitted to the inside of an external auditory canal (or an external auditory meatus) while the binaural device 310 or 320 is worn on the user's ear, at least a portion of the sound hole may be exposed to the inside of the external auditory canal or may contact with the inner wall of the external auditory canal from the opening on the auricle of the external auditory canal. For example, when the user makes a voice utterance while wearing the binaural device 310 or 320, at least some of a tremor from the utterance may be transmitted through the user's skin, muscles, or bones, and the transmitted tremor may be collected as ambient sound by the second microphone 355 or 355-1 inside the ear.

According to an embodiment, the second microphone 355 or 355-1 may include various types of microphones (e.g., an in-ear microphone, an inner microphone, or a bone conduction microphone) for collecting sound from the inner cavity of the user's ear. For example, the second microphone 355 or 355-1 may include at least one air conduction microphone and/or bone conduction microphone for detecting speech. The air conduction microphone may detect speech (e.g., an utterance of the user) transmitted through the air and may output a speech signal corresponding to the detected speech. The bone conduction microphone may measure a vibration of a bone (e.g., a skull) caused by the vocalization of the user and may output a speech signal corresponding to the measured vibration. The bone conduction microphone may be referred to as a bone conduction sensor or various other names. Speech detected by the air conduction microphone may be speech mixed with external noise while the user's utterance is being transmitted through the air. Since the speech detected by the bone conduction microphone is from the vibration of a bone, the speech may include less external noise (or the influence of noise).

In FIG. 3, the first microphone 350 or 350-1 and the second microphone 355 or 355-1 are respectively illustrated as being installed in the binaural device 310 or 320, one of each, but the number is not limited thereto. A plurality of the first microphone 350 or 350-1, which is an external microphone, and a plurality of the second microphone 355 or 355-1, which is an internal microphone, may be installed in the binaural device 310 or 320. Although not shown in FIG. 3, the binaural device 310 or 320 may further include an accelerator for speech activity detection (VAD) and a vibration sensor (e.g., a speech pickup unit (VPU) sensor).

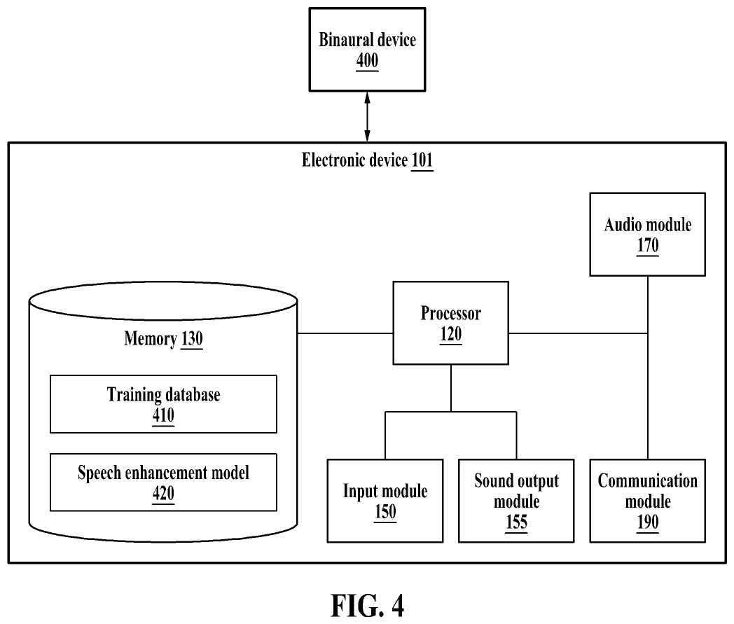

According to an embodiment, the binaural device 310 or 320 may include a sensor for detecting its worn state on the user's ears. For example, the binaural device 310 or 320 may include a sensor (e.g., an infrared sensor or a laser sensor) for detecting a distance from an object or a sensor (e.g., a touch sensor) for detecting contact with the object. The binaural device 310 or 320 may detect a distance from or contact with the skin through a sensor when worn on the user's ear to generate a signal and may recognize whether the binaural device 310 or 320 is currently being worn. The binaural device 310 or 320 may correspond to a binaural device 400 of FIG. 4.

According to an embodiment, the audio module 170 described above with reference to FIGS. 1 and 2 may be included in the electronic device 101. The descriptions provided with reference to FIGS. 1 and 2 may not be repeated here. The electronic device 101 may perform audio signal processing, such as noise processing (e.g., noise suppressing), frequency band adjustment, or gain adjustment through the audio module 170 (e.g., the audio signal processor 240 of FIG. 2).

According to an embodiment, the electronic device 101 may establish a communication channel with the binaural device 310 or 320 and may transmit a specified audio signal to the binaural device 310 or 320 or may receive an audio signal from the binaural device 310 or 320. For example, the electronic device 101 may be various electronic devices, such as a portable terminal, a terminal device, a smartphone, a personal computer (PC), a server, a laptop, a tablet PC, a virtual reality (VR)/augmented reality (AR) device, or a pad-type electronic device, for establishing a communication channel (e.g., a wired or wireless communication channel) with the binaural device 310 or 320.

According to an embodiment, the electronic device 101 may perform a binaural speech enhancement process on an audio signal to be output through the binaural device 310 or 320. The audio signal with improved audio quality through the binaural speech enhancement process may be provided to the user wearing the binaural device 310 and 320. In an embodiment, a signal-to-noise ratio (SNR) of a speech signal may be improved with a noise component being reduced from the audio signal by the binaural speech enhancement process, and the spatial characteristics or spatial cue of the noise component may be preserved. In the binaural speech enhancement process, a noise component, e.g., the information on the sound image position of interference noise and/or diffuse noise, which may be included in the audio signal may be preserved. The interference noise may be noise transmitted with directionality from a sound source from which the noise signal is generated, and the diffuse noise may be noise transmitted with the same audio intensity from all directions without directionality.

For the interference noise, information on the direction in which the noise signal is transmitted may be used as important information by the user. For example, if an object, such as a vehicle, approaches the user, or there is a gunshot around the user, the sound of the vehicle and the gunshot may be noise signals, and the direction from which the sound of the vehicle and the gunshot come may be significant for the user. For the user's safety, it may be important to find out the direction from which the user hears the sound of the vehicle or the gunshot. If the directional information of the noise signals is not preserved in a noise reduction process, the user may not readily determine from where the sound of the vehicle or the gunshot comes. Even in the case of the diffuse noise, if spatial characteristics or a spatial cue are not preserved in the noise reduction process, a sound image may be concentrated in the center. This may give the user a distorted experience as if a noise signal is generated from a point sound source. Accordingly, the non-directionality of the diffuse noise may also need to be preserved in the noise reduction process for the diffuse noise.

According to various embodiments described in the present disclosure, the binaural speech enhancement process for preserving the spatial characteristics (e.g., directionality) of a noise component while reducing the noise component of an audio signal to be output through the binaural device 310 or 320 may be provided. In an embodiment, an audio signal obtained from the microphones 350, 350-1, 355, and 355-1 included in the binaural device 310 or 320 may be transmitted to the electronic device 101, and the electronic device 101 may generate the audio signal with its noise component being reduced using a neural network-based speech enhancement model while its spatial characteristics of the noise component are preserved. The speech enhancement model may adjust a ratio between a speech component and a noise component included in the audio signal and may preserve (e.g., preserve the directionality and sound image of the speech component and the noise component) a binaural cue of the noise component in addition to the speech component. According to an embodiment, the speech enhancement model may be trained through the training operations of the speech enhancement model described with reference to FIGS. 4, 5, 6, 7 and 8. The electronic device 101 may provide the generated audio signal to the user through the binaural device 310 or 320. The audio signal for the left channel may be provided through the binaural device 310, and the audio signal for the right channel may be provided through the binaural device 320.

FIG. 4 is a block diagram illustrating an example configuration of an electronic device for performing training operations of a speech enhancement model, according to various embodiments.

Referring to FIG. 4, the electronic device 101 may include the input module 150 for receiving a user input, the sound output module 155 for outputting sound to the outside, the audio module 170 for controlling the output volume of audio output from the electronic device 101, the communication module (e.g., including communication circuitry) 190 for performing communication with the binaural device 400 (e.g., the binaural devices 310 or 320 of FIG. 3), the one or more processors (e.g., including processing circuitry) 120, and/or the one or more memories 130 for storing computer-executable instructions executable by the one or more processors 120. The electronic device 101 may include fewer or more configurations than the various configurations described above with reference to FIG. 1.

The electronic device 101, the processor 120, the memory 130, the input module 150, the sound output module 155, the audio module 170, and the communication module 190 may correspond respectively to the electronic device 101, the processor 120, the memory 130, the input module 150, the sound output module 155, the audio module 170, and the communication module 190 described above with reference to FIGS. 1, 2 and 3 (which may be referred to as FIGS. 1 to 3), and the description provided with reference to FIGS. 1 to 3 may not be repeated here. The binaural device 400 may correspond to the binaural device 310 or 320 described with reference to FIG. 3 and may be a two-channel audio output device, such as wired/wireless earphones, hearing aids, headsets, or smart glasses.

In an embodiment, the electronic device 101 may perform various operations while communicating with the binaural device 400. For example, the electronic device 101 may establish a short-range communication channel (e.g., a Bluetooth™ module-based communication channel) with the binaural device 400 through the communication module 190. The electronic device 101 may output an audio signal through the sound output module 155 and may receive an audio signal obtained through a microphone (e.g., the external microphone 350 or 350-1 and/or the second microphone 355 or 355-1, which is the internal microphone, as described above with reference to FIG. 3) of the binaural device 400. The audio module 170 of the electronic device 101 may control audio volume output to the binaural device 400.

According to an embodiment, the electronic device 101 may perform training operations for training a speech enhancement model 420 (e.g., a speech enhancement model 600) based on a neural network. The electronic device 101 for performing the training operations may include the one or more processors 120 and the one or more memories 130 for storing the instructions executable by the one or more processors 120. When the instructions stored in the one or more memories 130 are executed by the one or more processors 120, the executed instructions may cause the electronic device 101 to perform the following operations.

In an embodiment, the processor 120 may select speech data, room impulse response data, and noise data from a training database 410. The training database 410 may be a database that stores training data for training the speech enhancement model 420. For example, the speech data, the room impulse response data, and the noise data may be prepared training data.

In an embodiment, the noise data may include interference noise data and diffuse noise data. The interference noise data may be training data for a noise signal with directionality, and the diffuse noise data may be training data for a noise signal without directionality. The room impulse response data may be data representing the impulse response characteristics of an audio signal in space. Room impulse response data from the sound image position of speech data to a binaural device 400 and room impulse response data from the sound image position of the interference noise data to the binaural device 400.

In an embodiment, the processor 120 may determine a binaural input signal based on the selected speech data, the selected room impulse response data, and the selected noise data. In an embodiment, the processor 120 may determine a binaural input signal by applying the selected speech data, the selected room impulse response data, and the selected noise data to defined mathematical modeling (e.g., Equation 2 below). The binaural input signal is an audio signal that is input to the speech enhancement model 420 and may include an audio signal for a left channel and an audio signal for a right channel.

In an embodiment, the processor 120 may obtain a binaural output signal from the speech enhancement model 420 based on a neural network with the binaural input signal as an input. The speech enhancement model 420 may be a model for outputting the binaural output signal that reduces the intensity of a noise component while maintaining the directionality of the noise component included in the binaural input signal. The binaural output signal may be an audio signal that is output from the speech enhancement model 420 after binaural speech enhancement processing is performed by the speech enhancement model 420.

In an embodiment, a neural network model, such as the speech enhancement model 420, may be created through learning. Being created through learning may indicate a defined operation rule or neural network model is created to achieve desired characteristics (or purposes) after a basic neural network model is trained through a learning algorithm using a large amount of training data. For example, such learning may occur by a device itself on which the training operations according to the present disclosure are performed or through a separate server and/or system. The examples of the learning algorithm may include supervised learning, unsupervised learning, semi-supervised learning, or reinforcement learning, but examples are not limited thereto.

In an embodiment, the neural network model may include a plurality of neural network layers. Each of the plurality of neural network layers has a plurality of weight values and may perform a neural network operation through an operation between the operation result of a previous layer and the plurality of weight values. The plurality of weight values of the plurality of neural network layers may be optimized by the training result of the neural network model. For example, the plurality of weight values may be updated during the learning process such that a loss value or cost value obtained from the neural network model is reduced or minimized. The neural network model may include a DNN. For example, the DNN may include a CNN, an RNN, an RBM, a DBN, a BRDNN, a deep Q-network, or the like, but examples are not limited thereto.

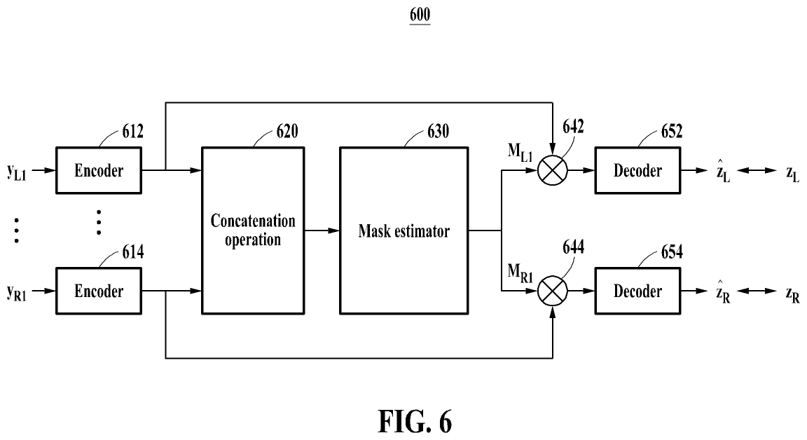

In an embodiment, the speech enhancement model 420 may include an encoder (e.g., an encoder 612 or 614 of FIG. 6) that converts the binaural input signal into a binaural input signal in a frequency domain, a mask estimator (e.g., a mask estimator 630 of FIG. 6) that determines a mask value to be applied to the binaural input signal in the frequency domain based on a noise suppression parameter related to the degree of noise suppression, and a decoder (e.g., a decoder 652 or 654 of FIG. 6) that converts a result signal obtained by applying the determined mask value to the binaural input signal in the frequency domain into a binaural output signal in a time domain. In an embodiment, the noise suppression parameter may be randomly selected within a specified range of values. For example, the noise suppression parameter may be selected as a random value within a range of 0 to 1. In addition, the speech enhancement model 420 used in various embodiments may be implemented in various embodiments depending on a manufacturer of the electronic device 101 or a user of the electronic device 101 and is not limited to the foregoing examples.

In an embodiment, the processor 120 may determine a target binaural signal based on the selected speech data, the selected room impulse response data, and the selected noise data. The target binaural signal may be a target binaural signal for the left channel and a target binaural signal for the right channel. The target binaural signal for the left channel may be determined based on room impulse response data for the left channel and noise data for the left channel. The target binaural signal for the right channel may be determined based on room impulse response data for the right channel and noise data for the right channel.

In an embodiment, the processor 120 may determine the target binaural signal based on the selected speech data, room impulse response data related to the selected speech data, the selected noise data, room impulse response data related to the selected noise data, and a noise suppression parameter related to a suppression degree of noise. In an embodiment, the noise suppression parameter may be randomly selected within a specified range of values. The noise suppression parameter used to determine the target binaural signal may be the same as the noise suppression parameter applied to the speech enhancement model 420 to obtain the binaural output signal. In an embodiment, the processor 120 may determine the target binaural signal by applying the selected speech data, the room impulse response data related to the selected speech data, the selected noise data, the room impulse response data related to the selected noise data, and the noise suppression parameter to the defined mathematical modeling (e.g., Equations 3 and 4).

In an embodiment, the processor 120 may control to update a parameter of the speech enhancement model 420, based on the obtained binaural output signal from the speech enhancement model 420 and the determined target binaural signal. For example, the speech enhancement model 420 may include weight coefficients and/or biases of a neural network.

In an embodiment, the processor 120 may determine a loss (or loss data) based on the obtained binaural output signal from the speech enhancement model 420 and the determined target binaural signal and may control to update a parameter of the speech enhancement model 420 based on the determined loss. The loss may include a loss based on the difference between an actual result and a result obtained by the neural network model performing forward propagation using input data. For example, the loss may include a loss based on the difference between a target binaural signal corresponding to the actual result and a binaural output signal that is output based on a binaural input signal to which the speech enhancement model 420 is input. In addition, the loss may include a loss based on the difference between the two channels of the binaural output signal and/or the difference between the two channels of the target binaural signal.

In an embodiment, the processor 120 may update a parameter of the speech enhancement model 420, based on at least one loss of a speech-to-distortion ratio loss based on the obtained binaural output signal from the speech enhancement model 420 and the determined target binaural signal, a loss based on an inter-channel level-difference (ICLD), and a loss based on an inter-channel time-difference (ICTD). The ICLD is information that characterizes the signal level difference of an audio signal between the left channel and the right channel, and the ICTD is information that characterizes the timing difference between the left channel and the right channel.

In an embodiment, the processor 120 may gradually update a parameter of the speech enhancement model 420 to a desirable value by performing an error backpropagation-based machine learning algorithm that uses the gradient of the determined loss. In the error backpropagation-based machine learning algorithm, a parameter of the speech enhancement model 420 may be updated such that a loss calculated using a loss function is reduced.

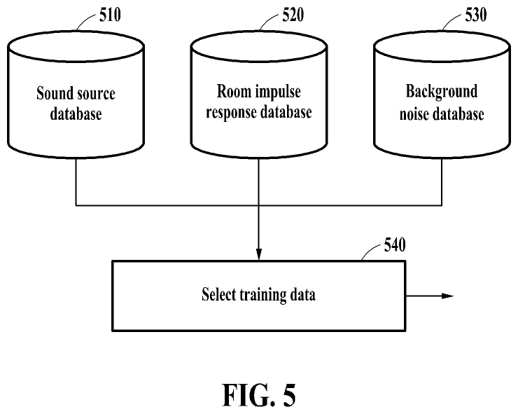

FIG. 5 is a diagram illustrating an example operation of selecting training data, according to various embodiments.

Referring to FIG. 5, a training database (e.g., the training database 410 of FIG. 4), according to an embodiment, may store a sound source database 510, a room impulse response database 520, and a background noise database 530. Data stored in the sound source database 510, the room impulse response database 520, and the background noise database 530 may correspond to raw data.

In an embodiment, the sound source database 510 may store a speech dataset, which is a target of binaural speech enhancement, and a noise dataset for interference noise. For example, a publicly available dataset or a dataset obtained through direct recording in a recording studio may be used as the speech dataset and the noise dataset.

In an embodiment, the room impulse response database 520 may store room impulse response datasets from various environments. For example, the room impulse response data to be used for learning may be extracted from audio signals obtained by microphones of a binaural device through inverse filtering or other processes when test signals, such as a sine sweep or a maximum length sequence (MLS), are played at various distances and various angles (e.g., azimuth or elevation) while the binaural device is attached to a simulator device (e.g., a head and torso simulator device). In addition to the method of directly obtaining the room impulse response data, the room impulse response data may also be obtained through an acoustic simulator device that may simulate multichannel microphone signals for both ears under various reverberant environments.

In an embodiment, the background noise database 530 may store a noise dataset for diffuse noise. As the noise dataset for diffuse noise, for example, a dataset directly obtained from a binaural device (e.g., the binaural device 310 or 320 of FIG. 3 or the binaural device 400 of FIG. 4) in various environments or a dataset generated through an acoustic simulator may be used.

The processor 120 of the electronic device 101 may select data to be used for learning from each of the sound source database 510, the room impulse response database 520, and the background noise database 530 and may select, in operation 540, training data to be used for training a speech enhancement model (e.g., the speech enhancement model 420 of FIG. 4), based on the selected data. For example, based on the selected data, the processor 120 may determine a binaural input signal to be input to the speech enhancement model and a target binaural signal corresponding to a desired signal to be output by the speech enhancement model.

In an embodiment, a binaural device with M multichannel microphones each on the left and right sides is assumed. In this case, an input signal y(t) incident on a microphone of the binaural device may be expressed by Equation 1 below.

$$y ( t ) = {[ {y}_{{L}_{1}} ( t ) , {y}_{{L}_{2}} ( t ) , … , {y}_{{L}_{M}} ( t ) , {y}_{{R}_{1}} ( t ) , {y}_{{R}_{2}} ( t ) , … , {y}_{{R}_{M}} ( t ) ]}^{T} \qquad [ Equation 1 ]$$

Here, L denotes the left and R denotes the right. 1, 2, . . . , M denote the number of a microphone channel and T denotes transpose.

The input signal y(t) may be modeled as Equation 2 below.

$$y ( t ) = {h}_{s} ( t ) * s ( t ) + {h}_{i} ( t ) * i ( t ) + v ( t ) \qquad [ Equation 2 ]$$

Here, s denotes a speech component of speech data (or a target speech) selected for learning, and i denotes an interference noise component of interference noise data selected for learning. v denotes a multichannel noise component including a diffuse noise component of diffuse noise data selected for learning and a self-noise component generated by a microphone of the binaural device. hₛ(t) denotes a room impulse response from the sound image position of the speech data to the binaural device (or the microphone of the binaural device). hᵢ(t) denotes a room impulse response from the sound image position of the interference noise data to the binaural device (or the microphone of the binaural device).

Based on a reference microphone channel (assumed to be microphone channel 1) in the binaural device, the target binaural signals of binaural speech enhancement processing may be expressed by Equations 3 and 4. Equation 3 represents the target binaural signal for a left channel, and Equation 4 represents the target binaural signal for a right channel.

$${z}_{L} ( t ) = {h}_{s , {L}_{1}} ( t ) * s ( t ) + {g}_{i} \cdot {h}_{i , {L}_{1}} ( t ) * i ( t ) + {g}_{v} \cdot {v}_{{L}_{1}} ( t ) \qquad [ Equation 3 ]$$

$${z}_{R} ( t ) = {h}_{s , {R}_{1}} ( t ) * s ( t ) + {g}_{i} \cdot {h}_{i , {R}_{1}} ( t ) * i ( t ) + {g}_{v} \cdot {v}_{{R}_{1}} ( t ) \qquad [ Equation 4 ]$$

Here, gᵢ denotes a noise suppression parameter that determines the degree of suppression against interference noise, and gᵥ denotes a noise suppression parameter that determines the degree of suppression against diffuse noise. In an embodiment, gᵢ and gᵥ may be adjustable constants. For example, if gᵢ is set to 0.1, an interference noise component in the target binaural signal may be attenuated by 20 dB.

FIG. 6 is a diagram illustrating an example structure and example training operations of a speech enhancement model, according to various embodiments.

Referring to FIG. 6, the speech enhancement model 600 (e.g., the speech enhancement model 420 of FIG. 4), according to an embodiment, may include encoders 612 and 614, a mask estimator 630, and decoders 652 and 654.

A multichannel binaural input signal obtained from a binaural device (e.g., the binaural device 310 or 320 of FIG. 3 or the binaural device 400 of FIG. 4) may be input to the speech enhancement model 600. A multichannel binaural input signal Y (Y∈ [symbol] ^{T×2M}, in which T denotes the length of an audio signal and M denotes the number of microphone channels included in the binaural device) may be input to the encoders 612 and 614. The encoders 612 and 614 may include the encoder 612 that receives a binaural input signal (e.g., y_{L1}) of a left channel and the encoder 614 that receives a binaural input signal (e.g., y_{R1}) of a right channel. In an embodiment, the number of encoders 612 and 614 may be the same as the number of microphone channels corresponding to the left and right channels.

The encoders 612 and 614 may convert a binaural input signal in a time domain into a binaural input signal in a frequency domain (or a latency domain). In an embodiment, the encoders 612 and 614 may be implemented as convolutional layers or modules for performing a short-time Fourier transform (STFT) on the binaural input signal. The encoders 612 and 614 may generate a frequency spectrum signal for the binaural input signal y_{L1} or y_{R1} in the time domain.

After binaural input signals in the frequency domain are output from the encoders 612 and 614, a concatenation operation 620 may be performed on the binaural input signals in the frequency domain. In an embodiment, the binaural input signals in the frequency domain may be connected to or combined with each other to form a single signal through the concatenation operation 620.

The mask estimator 630 may determine a mask value to be applied to a binaural input signal in the frequency domain based on a noise suppression parameter. Here, the noise suppression parameter may be the noise suppression parameters gᵢ and gᵥ used to determine the target binaural signal in Equations 3 and 4. Based on the noise suppression parameter, the mask estimator 630 may output a mask value M_{L}_{₁} to be multiplied by a left reference channel and a mask value M_{R}_{₁} to be multiplied by a right reference channel. The mask values M_{L}_{₁} and M_{R}_{₁} are values that determine how much to reduce the influence of a noise component in a binaural input signal and may be a complex-valued mask including complex numbers or a real-valued mask including real numbers. For example, the mask values M_{L}_{₁} and M_{R}_{₁} may include values in a range of 0 to 1. In an embodiment, a temporal convolutional network (TCN) or a dual path recurrent neural network (DPRNN) may be used as the mask estimator 630, but examples are not limited to the foregoing examples.

The mask values M_{L1} and M_{R1} determined by the mask estimator 630 may be applied respectively to the binaural input signals, output from the encoders 612 and 614, in the frequency domain. For example, in operation 642, the mask value M_{L1} may be multiplied by the binaural input signal, output from the encoder 612, in the frequency domain, and, in operation 644, the mask value M_{R1} may be multiplied by the binaural input signal, output from the encoder 614, in the frequency domain.

The decoders 652 and 654 may convert a result signal obtained by applying a mask value to a binaural input signal in the frequency domain into a binaural output signal in the time domain again and output the converted signal. The decoders 652 and 654 may include the decoder 652 that outputs a binaural output signal \hat{z}_{L} of the left channel and the decoder 654 that outputs a binaural output signal \hat{z}_{R} of the right channel. In an embodiment, the decoders 652 and 654 may be implemented as or transposed convolutional layers or modules for performing an inverse short-time Fourier transform (ISTFT) on the result signal. Binaural output signals \hat{z}L (\hat{z}_{L}∈ [symbol] ^{T}) and \hat{z}_{R}(\hat{z}_{R}∈ [symbol] ^{T}) in the time domain may be obtained, in which binaural speech enhancement processing has been performed thereon by the decoders 652 and 654. The binaural output signals \hat{z}_{L} and \hat{z}_{R} may be signals having an enhanced SNR and the preserved spatial characteristics of a noise component, compared to the binaural input signals y_{L1} and y_{R1}.

In the learning operation of the speech enhancement model 600, according to an embodiment, losses may be determined based on the binaural output signals \hat{z}_{L} and \hat{z}_{R} and the target binaural signals z_{L} and z_{R} defined in Equations 3 and 4. At least one loss of a speech-to-distortion ratio loss, a loss based on an ICLD, and a loss based on an ICTD may be used for training the speech enhancement model 600. For example, the speech-to-distortion ratio loss may be determined based on the difference between the binaural output signal 2L and the target binaural signal z_{L} and/or the difference between the binaural output signal z_{R} and the target binaural signal z_{R}. The loss based on an ICLD may be determined based on the signal level difference between the binaural output signals \hat{z}_{L} and \hat{Z}R and/or the signal level difference between the target binaural signals z_{L} and z_{R}. The loss based on an ICTD may be determined based on the timing difference between the binaural output signals \hat{z}_{L} and \hat{z}_{R} and/or the timing difference between the target binaural signals z_{L} and z_{R}.

In an embodiment, a loss function may be determined based on the sum of the speech-to-distortion ratio loss, the loss based on an ICLD, and the loss based on an ICTD, and a parameter of the speech enhancement model 600 may be updated based on the loss function. For example, a parameter of the speech enhancement model 600 may be updated such that a value of the loss function may be reduced through an error backpropagation-based machine learning algorithm.

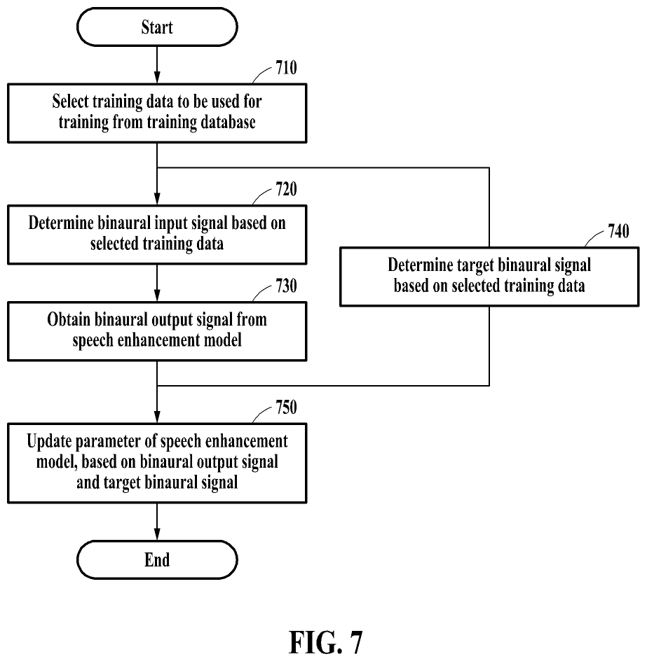

FIG. 7 is a flowchart illustrating an example method of operating an electronic device for training a speech enhancement model, according to various embodiments. In an embodiment, at least one of the operations of FIG. 7 may be simultaneously or parallelly performed with one another, and the order of the operations may be changed. In addition, at least one of the operations may be omitted or another operation may be additionally performed.

Referring to FIG. 7, in operation 710, the electronic device 101 may select training data to be used for training from a training database (e.g., the training database 410 of FIG. 4). For example, the electronic device 101 may select speech data, room impulse response data, and noise data from the training database. In an embodiment, the noise data may include interference noise data and diffuse noise data. The room impulse response data from the sound image position of speech data to a binaural device (e.g., the binaural device 300) and the room impulse response data from the sound image position of the interference noise data to the binaural device (e.g., the binaural device 300 of FIG. 3 or the binaural device 400 of FIG. 4).

In operation 720, the electronic device 101 may determine a binaural input signal based on selected training data including, for example, the selected speech data, the selected room impulse response data, and the selected noise data. In an embodiment, the electronic device 101 may determine the binaural input signal by applying the selected speech data, the selected room impulse response data, and the selected noise data to defined mathematical modeling (e.g., Equation 2).

In operation 730, the electronic device 101 may obtain a binaural output signal from a neural neural-based speech enhancement model (e.g., the speech enhancement model 420 of FIG. 4 or the speech enhancement model 600 of FIG. 6) with the binaural input signal as an input. In an embodiment, the electronic device 101 may obtain a binaural output signal on which binaural speech enhancement processing has been performed from the speech enhancement model 600 by inputting the binaural input signal to the speech enhancement model 600 described with reference to FIG. 6.

In operation 740, the electronic device 101 may determine a target binaural signal based on the selected training data, including, for example, speech data, the room impulse response data, and the noise data that are selected in operation 710. The target binaural signal may be a target binaural signal for a left channel and a target binaural signal for a right channel. The electronic device 101 may determine the target binaural signal for the left channel based on room impulse response data for the left channel and noise data for the left channel. The electronic device 101 may determine the target binaural signal for the right channel based on room impulse response data for the right channel and noise data for the right channel. In an embodiment, the electronic device 101 may determine the target binaural signal by applying the selected speech data, the room impulse response data related to the selected speech data, the selected noise data, the room impulse response data related to the selected noise data, and the noise suppression parameter to the defined mathematical modeling (e.g., Equations 3 and 4).

In operation 750, the electronic device 101 may update a parameter of the speech enhancement model, based on the binaural output signal obtained from the speech enhancement model and the determined target binaural signal. In an embodiment, the electronic device 101 may determine a loss based on the obtained binaural output signal from the speech enhancement model and the determined target binaural signal and may control to update a parameter of the speech enhancement model based on the determined loss.

In an embodiment, the electronic device 101 may update a parameter of the speech enhancement model, based on at least one loss of a speech-to-distortion ratio loss based on the obtained binaural output signal from the speech enhancement model and the determined target binaural signal, a loss based on an ICLD, and a loss based on an ICTD. In an embodiment, the electronic device 101 may update a parameter of the speech enhancement model using an error backpropagation-based machine learning algorithm. A parameter of the speech enhancement model may be adjusted such that the binaural output signal output from the speech enhancement model is similar to the target binaural signal.

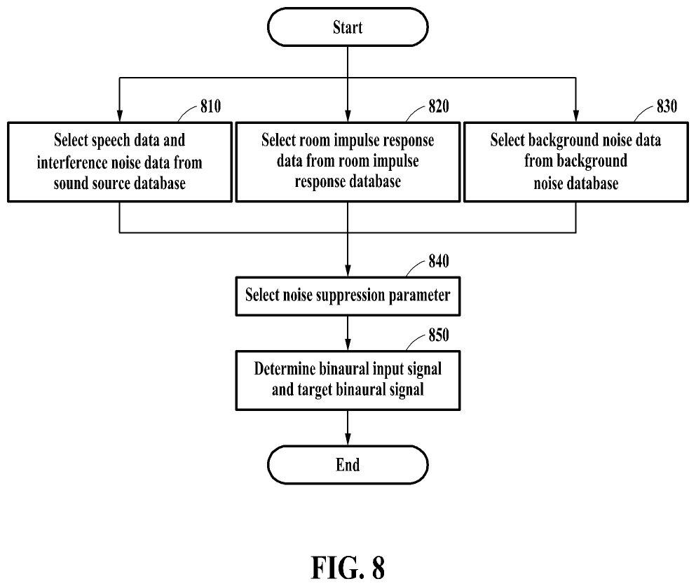

FIG. 8 is a flowchart illustrating example operations of determining a binaural input signal and a target binaural signal for training a speech enhancement model, according to various embodiments. In an embodiment, at least one of operations of FIG. 8 may be simultaneously or parallelly performed with one another, and the order of the operations may be changed. In addition, at least one of the operations may be omitted or another operation may be additionally performed.

Referring to FIG. 8, in operation 810, the electronic device 101 may select (or sample) speech data and interference noise data from a sound source database (e.g., the sound source database 510 of FIG. 5). The sound source database may store various pieces of speech data and various pieces of interference noise data, which are the target of binaural speech improvement. In an embodiment, speech data and interference noise data may be randomly selected from the sound source database 510.

In operation 820, the electronic device 101 may select (or sample) room impulse response data from a room impulse response database (e.g., the room impulse response database 520 of FIG. 5). The room impulse response database may store room impulse response data representing room impulse responses in various environments. In an embodiment, the electronic device 101 may select room impulse response data to be applied to speech data and room impulse response data to be applied to interference noise data from the room impulse response database.

In operation 830, the electronic device 101 may select (or sample) background noise data from a background noise database (e.g., the background noise database 530 of FIG. 5). The background noise database may store various pieces of diffuse noise data.

Operations 810, 820 and 830 may be included in operation 710 of FIG. 7.

In operation 840, the electronic device 101 may select a noise suppression parameter to determine the degree of noise suppression for a binaural input signal. For example, the electronic device 101 may select a random value from 0 to 1 as the noise suppression parameter. The noise suppression parameter may include a noise suppression parameter for determining the degree of suppression of an interference noise component and a noise suppression parameter for determining the suppression information of a diffuse noise component.

In operation 850, the electronic device 101 may determine a binaural input signal and a target binaural signal based on the selected speech data, the selected interference noise data, the selected room impulse response data, the selected background noise data, and the selected noise suppression parameter. In an embodiment, the electronic device 101 may determine the binaural input signal that is input to the speech enhancement model through Equation 2 above and may determine the target binaural signal through, for example, Equations 3 and 4.

Operations 840 and 850 may include operations 720 and 740 of FIG. 7.

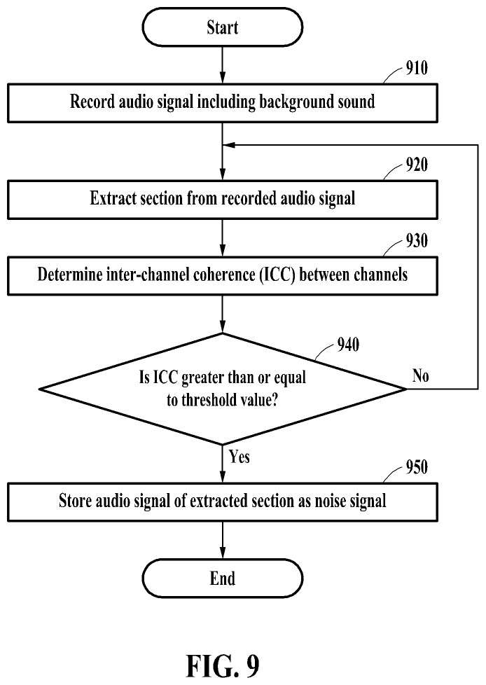

FIG. 9 is a flowchart illustrating example operations of obtaining diffuse noise data from a recorded audio signal, according to various embodiments. In an embodiment, at least one of the operations of FIG. 9 may be simultaneously or parallelly performed with one another, and the order of the operations may be changed. In addition, at least one of the operations may be omitted or another operation may be additionally performed.

Referring to FIG. 9, in operation 910, a binaural device (e.g., the binaural device 310 or 320 of FIG. 3 or the binaural device 400 of FIG. 4) may record an audio signal including background sound. The background sound may include a noise signal, and the noise signal may include an interference noise signal with directionality and/or a diffuse noise signal without directionality. The recorded audio signal may include an audio signal for a right channel and an audio signal for a left channel. The audio signal for the left channel may include, for example, an audio signal recorded by the microphones 350 and 355 of the binaural device 310 of FIG. 3, and the audio signal for the right channel may include an audio signal recorded by the microphones 350-1 and 355-1 of the binaural device 320 of FIG. 3.

In operation 920, the electronic device 101 may extract a random section from the audio signal recorded by the binaural device. For example, a partial audio signal in a specific time interval may be randomly extracted from the entire time interval of the recorded audio signal. For example, partial audio signals in the same time interval may be extracted between the audio signal for the left channel and the audio signal for the right channel.

In operation 930, the electronic device 101 may determine inter-channel coherence (or an inter-channel coherence value) between the extracted partial audio signal for the left channel and the extracted partial audio signal for the right channel. The inter-channel coherence may represent a correlation between the left channel and the right channel. The more similar the partial audio signals for the left channel and the right channel are to each other, the greater the inter-channel coherence may be.

In operation 940, the electronic device 101 may determine whether the determined inter-channel coherence is greater than or equal to a threshold value. If the determined inter-channel coherence is greater than or equal to the threshold value (‘Yes’ in operation 940), the electronic device 101 may store the audio signal of the section extracted in operation 920 as a noise signal in operation 950. The noise signal may be stored in a background noise database (e.g., the background noise database 530 of FIG. 5) and may be used as diffuse noise data for training a speech enhancement model (e.g., the speech enhancement model 420 of FIG. 4 or the speech enhancement model 600 of FIG. 6).

If the determined inter-channel coherence is less than the threshold value (‘No’ in operation 940), the electronic device 101 may return to operation 920 to extract a partial audio signal of another section from the audio signal recorded by the binaural device and may perform the operations from operation 930 again.

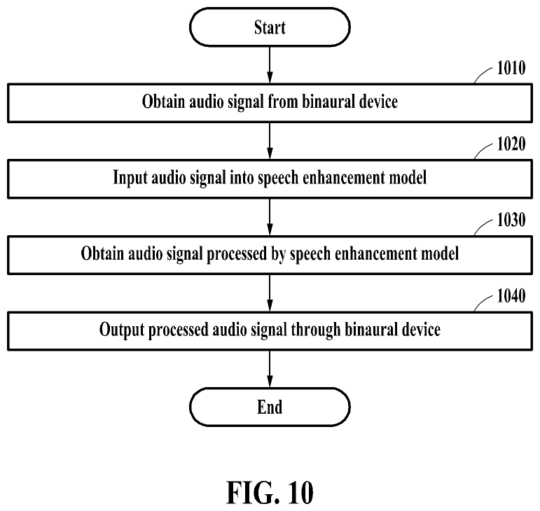

FIG. 10 is a flowchart illustrating an example method of providing an audio signal using a speech enhancement model, according to various embodiments. In an embodiment, at least one of the operations of FIG. 10 may be simultaneously or parallelly performed with one another, and the order of the operations may be changed. In addition, at least one of the operations may be omitted or another operation may be additionally performed.

Referring to FIG. 10, in operation 1010, the electronic device 101 may obtain an audio signal from a binaural device (e.g., the binaural device 310 or 320 of FIG. 3 or the binaural device 400 of FIG. 4). The binaural device may obtain a multichannel audio signal through equipped multichannel microphones and may transmit the obtained multichannel audio signal to the electronic device 101.

In operation 1020, the electronic device 101 may input the multichannel audio signal received from the binaural device into a trained speech enhancement model. In an embodiment, the speech enhancement model may be trained by the training method described with reference to FIGS. 4 to 8.

In operation 1030, the electronic device 101 may obtain an audio signal processed by the speech enhancement model. For example, the speech enhancement model may have the same structure as that of the speech enhancement model 600 of FIG. 6. The speech enhancement model may perform binaural speech enhancement processing on an input multichannel audio signal (e.g., a binaural input signal) to provide a binaural output signal with reduced noise while preserving the spatial characteristics of the noise. The binaural output signal may include a binaural output signal for a left channel and a binaural output signal for a right channel.

In operation 1040, the electronic device 101 may output an audio signal processed by the speech enhancement model through the binaural device. The electronic device 101 may provide a user with an audio signal with an improved SNR while maintaining the acoustic impression of a speech signal, interference noise, and diffuse noise through binaural speech enhancement processing using the speech enhancement model as described above.

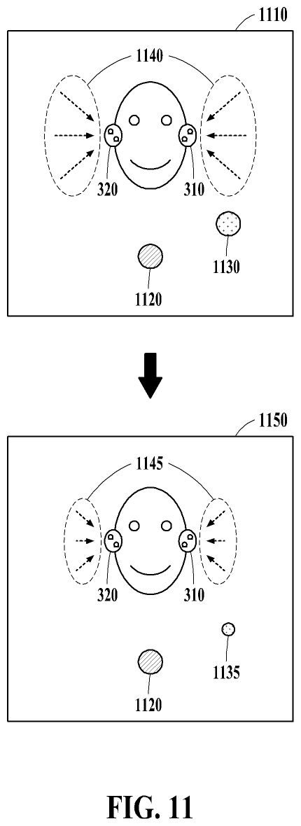

FIG. 11 is a diagram illustrating quality improvement of an audio signal through binaural speech enhancement processing, according to various embodiments.

FIG. 11 illustrates case 1110 where binaural speech enhancement processing is not performed and case 1150 where the binaural speech enhancement processing illustrated in the present disclosure is performed.

According to case 1110, an audio signal including a desired speech component 1120, an interference noise component 1130, and a diffuse noise component 1140 has been provided to a user through the binaural device 310 or 320. Reduction processing has not been performed on the interference noise component 1130 and the diffuse noise component 1140 in the audio signal provided to the user, and thus, the user may not readily recognize the desired speech component 1120 from the audio signal.

In case 1150, according to an embodiment, an audio signal including the desired speech component 1120, an interference noise component 1135, and a diffuse noise component 1145 has been provided to the user through the binaural device 310 or 320. However, compared to the interference noise component 1130 and the diffuse noise component 1140 in case 1110, the interference noise component 1135 and the diffuse noise component 1145 may be further reduced through binaural speech enhancement processing using a speech enhancement model. Accordingly, the audio signal (or a speech signal) with an improved SNR compared to case 1110 may be provided to the user. Even if the binaural speech enhancement processing is performed, the spatial cues of the interference noise component 1135 and the diffuse noise components 1145 may be preserved (e.g., sound image position may be preserved) and provided. Even after the binaural speech enhancement processing is performed, the user may recognize the directionality of the interference noise component 1135 and the non-directionality of the diffuse noise component 1145.

According to an example embodiment, the electronic device includes: at least one processor, comprising processing circuitry, and one or more memories storing instructions executable by the one or more processors, wherein the at least one processor, individually and/or collectively, is configured to execute the instructions and to cause the electronic device to: select speech data, room impulse response data, and noise data from the training database 410, determine a binaural input signal based on the selected speech data, the selected room impulse response data, and the selected noise data, obtain a binaural output signal from the speech enhancement model 420; 600 based on a neural network with the binaural input signal as an input, determine a target binaural signal based on the selected speech data, the selected room impulse response data, and the selected noise data, and control to update a parameter of the speech enhancement model 420; 600, based on the obtained binaural output signal from the speech enhancement model 420; 600 and the determined target binaural signal.

In an example embodiment, the at least one processor, individually and/or collectively, may be configured to cause the electronic device to: determine the target binaural signal based on the selected speech data, room impulse response data related to the selected speech data, the selected noise data, room impulse response data related to the selected noise data, and a noise suppression parameter related to a suppression degree of noise.

In an example embodiment, the noise suppression parameter may be randomly selected within a specified range of values.

In an example embodiment, the target binaural signal may include a target binaural signal for a left channel and a target binaural signal for a right channel. The target binaural signal for the left channel may be determined based on room impulse response data for the left channel and noise data for the left channel. The target binaural signal for the right channel may be determined based on room impulse response data for the right channel and noise data for the right channel.

In an example embodiment, the speech enhancement model may include an encoder configured to convert a binaural input signal in a time domain into a binaural input signal in a frequency domain, a mask estimator configured to determine a mask value to be applied to the binaural input signal in the frequency domain based on the noise suppression parameter, and a decoder configured to convert a result signal obtained by applying the determined mask value to the binaural input signal in the frequency domain into a binaural output signal in the time domain.

In an example embodiment, the at least one processor, individually and/or collectively, may be configured to cause the electronic device to: determine a loss based on the obtained binaural output signal from the speech enhancement model and the determined target binaural signal and update a parameter of the speech enhancement model, based on the loss.

In an example embodiment, the at least one processor, individually and/or collectively, may be configured to cause the electronic device to control to update a parameter of the speech enhancement model, based on at least one loss of a speech-to-distortion ratio loss based on the obtained binaural output signal from the speech enhancement model and the determined target binaural signal, a loss based on an inter-channel level-difference (ICLD), and a loss based on an inter-channel time-difference (ICTD).

In an example embodiment, the speech enhancement model may include a model configured to output the binaural output signal that reduces the intensity of a noise component while maintaining the directionality of the noise component included in the binaural input signal.

In an example embodiment, the noise data may include interference noise data and diffuse noise data.

In an example embodiment, the room impulse response data may include room impulse response data from the sound image position of speech data to the binaural device and room impulse response data from the sound image position of the interference noise data to the binaural device.

According to an example embodiment, a method of operating the electronic device includes: selecting speech data, room impulse response data, and noise data from the training database, determining a binaural input signal based on the selected speech data, the selected room impulse response data, and the selected noise data, obtaining a binaural output signal from the speech enhancement model based on a neural network with the binaural input signal as an input, determining a target binaural signal based on the selected speech data, the selected room impulse response data, and the selected noise data, and updating a parameter of the speech enhancement model, based on the obtained binaural output signal from the speech enhancement model and the determined target binaural signal.

In an example embodiment, the determining of the target binaural signal may include determining the target binaural signal based on the selected speech data, room impulse response data related to the selected speech data, the selected noise data, room impulse response data related to the selected noise data, and a noise suppression parameter related to a suppression degree of noise.

In an example embodiment, the updating of a parameter of the speech enhancement model may include determining a loss based on the obtained binaural output signal from the speech enhancement model and the determined target binaural signal and updating a parameter of the speech enhancement model, based on the loss.

In an example embodiment, the updating of a parameter of the speech enhancement model may include updating a parameter of the speech enhancement model, based on at least one loss of a speech-to-distortion ratio loss based on the obtained binaural output signal from the speech enhancement model and the determined target binaural signal, a loss based on an inter-channel level-difference (ICLD), and a loss based on an inter-channel time-difference (ICTD).

It should be appreciated that various embodiments of the present disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things, unless the relevant context clearly indicates otherwise. As used herein, “A or B”, “at least one of A and B”, “at least one of A or B”, “A, B or C”, “at least one of A, B and C”, and “A, B, or C,” each of which may include any one of the items listed together in the corresponding one of the phrases, or all possible combinations thereof. Terms such as “first”, “second”, or “first” or “second” may simply be used to distinguish the component from other components in question, and do not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., by wire), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., the internal memory 136 or the external memory 138) that is readable by a machine (e.g., the electronic device 101 of FIG. 1) For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to embodiments of the disclosure may be included and provided in a computer program product. The computer program product may be traded as a product between a seller and a buyer. The computer program product may be distributed in the form of a machine-readable storage medium (e.g., a compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to an embodiment, the integrated component may still perform one or more functions of each of the components in the same or similar manner as they are performed by a corresponding one among the components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
at least one processor comprising processing circuitry; and
one or more memories storing instructions executable by at least one processor,
wherein, the at least one processor, individually and/or collectively, is configured to execute the instructions and to cause the electronic device to:
select speech data, room impulse response data, and noise data from a training database,
determine a binaural input signal based on the selected speech data, the selected room impulse response data, and the selected noise data,
obtain a binaural output signal from a speech enhancement model based on a neural network with the binaural input signal as an input,
determine a target binaural signal based on the selected speech data, the selected room impulse response data, and the selected noise data, and update a parameter of the speech enhancement model, based on the obtained binaural output signal from the speech enhancement model and the determined target binaural signal.

2. The electronic device of claim 1, wherein
the at least one processor, individually and/or collectively, is configured to cause the electronic device to:
determine the target binaural signal based on the selected speech data, room impulse response data related to the selected speech data, the selected noise data, room impulse response data related to the selected noise data, and a noise suppression parameter related to a suppression degree of noise.

3. The electronic device of claim 2, wherein
the noise suppression parameter is randomly selected within a specified range of values.

4. The electronic device of claim 1, wherein
the target binaural signal comprises a target binaural signal for a left channel and a target binaural signal for a right channel,
wherein the target binaural signal for the left channel is determined based on room impulse response data for the left channel and noise data for the left channel, and
the target binaural signal for the right channel is determined based on room impulse response data for the right channel and noise data for the right channel.

5. The electronic device of claim 1, wherein
the speech enhancement model comprises:
an encoder configured to convert a binaural input signal in a time domain into a binaural input signal in a frequency domain;
a mask estimator configured to determine a mask value to be applied to the binaural input signal in the frequency domain based on the noise suppression parameter; and
a decoder configured to convert a result signal obtained by applying the determined mask value to the binaural input signal in the frequency domain into a binaural output signal in the time domain.

6. The electronic device of claim 1, wherein
the at least one processor, individually and/or collectively, is configured to cause the electronic device to:
determine a loss based on the obtained binaural output signal from the speech enhancement model and the determined target binaural signal, and
update a parameter of the speech enhancement model, based on the loss.

7. The electronic device of claim 6, wherein
the at least one processor, individually and/or collectively, is configured to cause the electronic device to:
update a parameter of the speech enhancement model, based on at least one loss of a speech-to-distortion ratio loss based on the obtained binaural output signal from the speech enhancement model and the determined target binaural signal, a loss based on an inter-channel level-difference, and a loss based on an inter-channel time-difference.

8. The electronic device of claim 1, wherein
the speech enhancement model includes:
a model configured to output the binaural output signal that reduces an intensity of a noise component while maintaining a directionality of the noise component included in the binaural input signal.

9. The electronic device of claim 1, wherein
the noise data comprises interference noise data and diffuse noise data.

10. The electronic device of claim 9, wherein
the room impulse response data comprises:
room impulse response data from a sound image position of speech data to a binaural device and room impulse response data from the sound image position of the interference noise data to the binaural device.

11. A method of operating an electronic device, the method comprising:
selecting speech data, room impulse response data, and noise data from a training database;
determining a binaural input signal based on the selected speech data, the selected room impulse response data, and the selected noise data;
obtaining a binaural output signal from a speech enhancement model based on a neural network with the binaural input signal as an input;
determining a target binaural signal based on the selected speech data, the selected room impulse response data, and the selected noise data; and
updating a parameter of the speech enhancement model, based on the obtained binaural output signal from the speech enhancement model and the determined target binaural signal.

12. The method of claim 11, wherein
the determining the target binaural signal comprises:
determining the target binaural signal based on the selected speech data, room impulse response data related to the selected speech data, the selected noise data, room impulse response data related to the selected noise data, and a noise suppression parameter related to a suppression degree of noise.

13. The method of claim 12, wherein
the noise suppression parameter is randomly selected within a specified range of values.

14. The method of claim 11, wherein
the speech enhancement model comprises:
an encoder configured to convert a binaural input signal in a time domain into a binaural input signal in a frequency domain;
a mask estimator configured to determine a mask value to be applied to the binaural input signal in the frequency domain based on the noise suppression parameter; and
a decoder configured to convert a result signal obtained by applying the determined mask value to the binaural input signal in the frequency domain into a binaural output signal in the time domain.

15. The method of claim 11, wherein
the updating a parameter of the speech enhancement model comprises:
determining a loss based on the obtained binaural output signal from the speech enhancement model and the determined target binaural signal; and
updating a parameter of the speech enhancement model, based on the loss.

16. The method of claim 15, wherein
the updating a parameter of the speech enhancement model comprises:
updating a parameter of the speech enhancement model, based on at least one loss of a speech-to-distortion ratio loss based on the obtained binaural output signal from the speech enhancement model and the determined target binaural signal, a loss based on an inter-channel level-difference, and a loss based on an inter-channel time-difference.

17. The method of claim 11, wherein
the speech enhancement model comprises:
a model configured to output the binaural output signal that reduces an intensity of a noise component while maintaining a directionality of the noise component included in the binaural input signal.

18. The method of claim 11, wherein
the noise data comprises interference noise data and diffuse noise data.

19. The method of claim 18, wherein
the room impulse response data comprises:
room impulse response data from a sound image position of speech data to a binaural device and room impulse response data from the sound image position of the interference noise data to the binaural device.

20. A non-transitory computer-readable storage medium storing instructions that, when executed by at least one processor, comprising processing circuitry, individually and/or collectively, cause an electronic device to perform the method of claim 11.
